(19) United States
(12) Patent Application Publication
(10) Pub. No.: US 2008/0135172 A1
(43) Pub. Date: Jun. 12, 2008

(54) Inserter system for handling RFID items

(75) Inventors: Richard Prochut, Southbury, CT (US); Russell W. Holbrook, Southbury, CT (US); Xavier A. Padros, New Milford, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/636,305

(22) Filed: Dec. 8, 2006

(51) Int. Cl. B32B 38/18; B32B 41/00

(52) U.S. Cl. 156/281; 156/350; 156/362

(57) ABSTRACT

A method and system for preparing mail pieces that include RFID enabled cards. The improvement provides enhanced tracking and control capabilities for such mail pieces. In an inserter control system, individual RFID signals of the RFID enabled cards are related to particular mail pieces in a mail piece production database. The corresponding RFID enabled cards are fed into the inserter system from a card feeder. An attaching device attaches the cards to a carrier sheet. The inserter system transports the cards and carrier sheets to different stations where other documents are joined with the carrier sheets. The assembled mail pieces are then inserted into envelopes to form finished mail pieces. Sensors are located within the system to detect the RFID signals of the individual cards. The sensed individual RFID numbers are compared with stored mail piece data. The system is programmed to process the mail piece based on instructions in the database corresponding to the sensed number. For example, if a sensed RFID signal does not match the RFID number that is expected for a particular mail piece that is expected at a location of the sensing, then the system generates an error signal.

### TECHNICAL FIELD

The present invention relates to an inserter system used to generate mail pieces having credit cards, or other items, having RFID signals.

### BACKGROUND OF THE INVENTION

Inserter systems, such as those applicable for use with the present invention, are typically used by organizations such as banks, insurance companies and utility companies for producing a large volume of specific mailings where the contents of each mail item are directed to a particular addressee. Also, other organizations, such as direct mailers, use inserts for producing a large volume of generic mailings where the contents of each mail item are substantially identical for each addressee. Examples of such inserter systems are the 8 series, 9 series, and APS™ inserter systems available from Pitney Bowes Inc. of Stamford, Conn.

In many respects, the typical inserter system resembles a manufacturing assembly line. Sheets and other raw materials (other sheets, enclosures, and envelopes) enter the inserter system as inputs. Then, a plurality of different modules or workstations in the inserter system work cooperatively to process the sheets until a finished mail piece is produced. The exact configuration of each inserter system depends upon the needs of each particular customer or installation.

Typically, inserter systems prepare mail pieces by gathering collations of documents on a conveyor. The collations are then transported on the conveyor to an insertion station where they are automatically stuffed into envelopes. After being stuffed with the collations, the envelopes are removed from the insertion station for further processing. Such further processing may include automated closing and sealing the envelope flap, weighing the envelope, applying postage to the envelope, and finally sorting and stacking the envelopes.

One specialized instance for use of inserters is to generate mail pieces for sending plastic cards (credit cards, membership cards, etc.) to customers. Typically these cards are fastened to a carrier sheet. The carrier sheet with the attached cards is then input into an inserter to be joined with other communication documents to be included in the same mail piece.

It is known that these types of plastic cards can be embedded with an RFID (radio frequency identification) transmitter. The transmitted RFID signal is typically an identification number for the card. For example, in a credit card, the RFID signal may include the credit card account identifier. A customer will typically use the RFID card to make payments by waving the card in the proximity of an RFID sensor at a point of sale.

### SUMMARY OF THE INVENTION

The present invention represents an improvement over the prior art by providing a method and system for preparing mail pieces that include RFID enabled cards. The improvement provides enhanced tracking and control capabilities for such mail pieces. In the preferred embodiment, the RFID enabled cards are credit cards, and the RFID signals represent account numbers.

In an inserter control system, individual RFID signals of the RFID enabled cards are related to particular mail pieces in a mail piece production database. The corresponding RFID enabled cards are fed into the inserter system from a card feeder. An attaching device attaches the cards to a carrier sheet. Attaching methods include the use of glue or tape. The inserter system transports the cards and carrier sheets to different stations where other documents are joined with the carrier sheets. The assembled mail pieces are then inserted into envelopes to form finished mail pieces.

During transport and assembly of the carrier sheets, sensors are located within the system to detect the RFID signals of the individual cards. The sensed individual RFID numbers are compared with mail piece data in the mail piece production database. Based on the sensed RFID number, the system is programmed to respond by processing the mail piece based on instructions in the database corresponding to the sensed number. For example, if an sensed RFID signal does not match the RFID number that is expected for a particular mail piece expected at a location of the sensing, then the system generates an error signal. Based on the error signal, the system can be arranged to outsort mail pieces as potentially being mis-assembled.

In a preferred embodiment, sensors for detecting the RFID signals of the cards are placed immediately upstream of the inserting location. In this embodiment, it is preferred that the inserting station be built from plastic, or other non-metallic parts, so as not to interfere with the RFID signal detection. This arrangement at the inserting station can help ensure that the final product includes the expected components. The RFID sensors may also be placed at a plurality of locations throughout the inserter system to enhance tracking and control capabilities. One such preferred location may be immediately downstream of the device for feeding the cards from the card feeder, to ensure that the expected cards are being fed into the system.

Carrier sheets may be arranged to include two cards on the sheet in a side-by-side arrangement. In this embodiment, the process of sensing the individual RFID numbers on the cards is carried out by a pair of sensors positioned to be proximal to the side-by-side cards on the carrier sheets.

Further details of the present invention are provided in the accompanying drawings, detailed description, and claims.

### BRIEF DESCRIPTION OF THE DRAWINGS

FIG. 1 represents a top view of an inserter arrangement that can be used with the present invention.

FIG. 2 presents a side view an module for inputting RFID cards into an inserter system.

FIG. 3 is an exemplary carrier sheet with attached RFID cards.

FIG. 4 represents an exemplary process flow for improved processing of RFID cards.

FIG. 5 depicts a preferred embodiment for specific placement of RFID sensors relative to transported documents.

### DETAILED DESCRIPTION

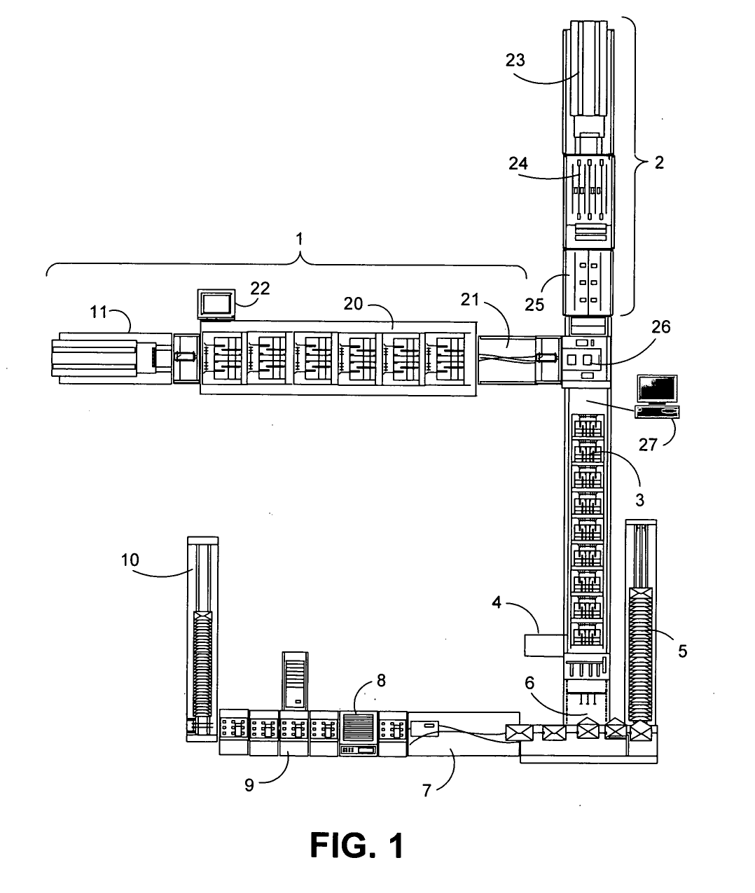

FIG. 1 depicts an exemplary inserter system incorporating the enhanced RFID processing capability. Card affixing module 1 includes components for preparing the RFID cards and carrier sheets. Primary input module 2 provides the primary control document for the mail pieces. A primary control document might typically be a letter, or an account statement, that includes personalized information directed to the mail piece recipient. The primary document and the card carrier sheet are merged together at an interface module 26.

The card affixing module 1 includes a carrier document feeder 11 that feeds onto a vacuum transport 20. A card feeder 22 provides the RFID cards to be placed on the fed carrier sheets. In one embodiment, a twist module 21 allows the sheet and cards to be turned over prior to joining the primary control document, in order to comply with user requirements. The twist module 21 rotates the document in the “roll” axis perpendicular to the transport direction. This translation and rotation is accomplished with a set of twisted transport belts and a set of document guide bars. The twist module operates at a continuous velocity and transfers the control document into the interface module 26.

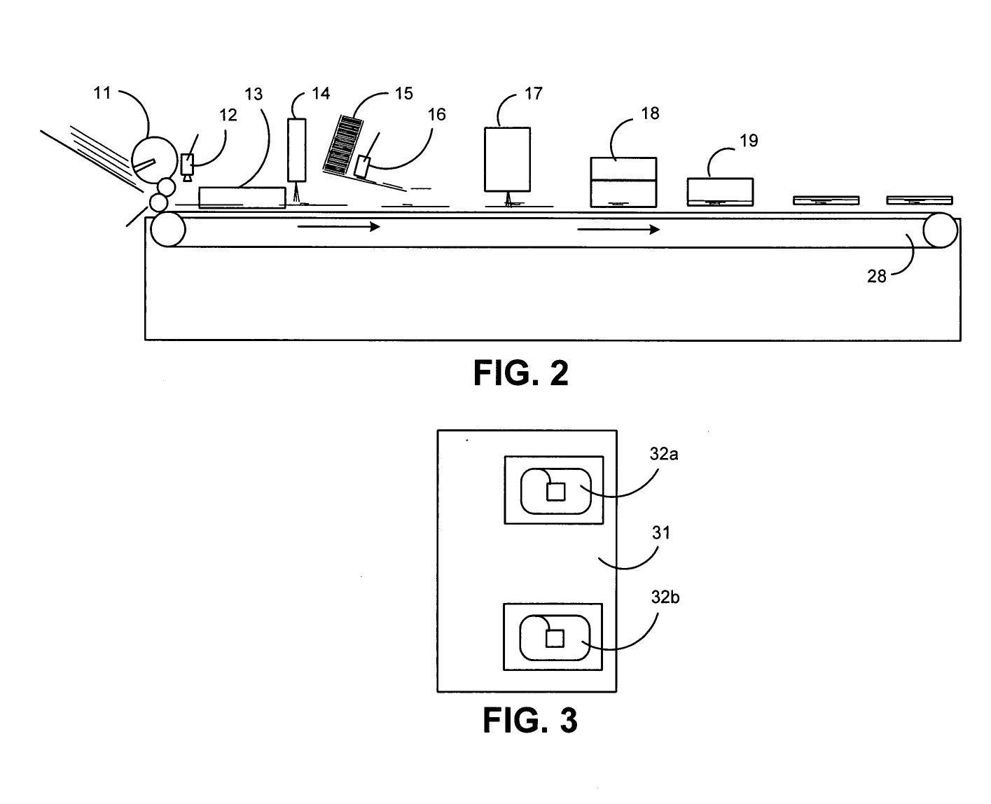

Within sorter interface module 26, the carrier sheet is reoriented (portrait to landscape) and transported into a buffer module. Preferably, the sorter interface 26 transports documents via a servo motor driven pusher belt system into a 3 stage buffering sub module for staging and feeding to the chassis deck 3. The completed carrier/card matched document is fed to the deck downstream of a “leap frog” arrangement, as described in co-pending application Ser. No. 11/583415 filed Oct. 18, 2006, assigned to the assignee of the present application, and incorporated by reference herein. The primary document is then transported onto the top of the carrier document which retains address bearing position on the chassis 3. (Components of the card affixing module 1 are further described in connection with FIG. 2.)

The primary input module 2 preferably includes a high capacity sheet feeder 23 that provides the control documents to be included in the mail pieces. The control documents may typically include a barcode that is scanned during processing to track the mail piece creation, and to control mail piece processing. The inserter control system 27 includes a database called a Mail Run Data File (MRDF) that includes mail piece data and assembly instructions for each mail piece to be created. In the preferred embodiment, the MRDF data includes how many RFID cards are associated with each mail piece.

The MRDF also includes data representing the respective RFID signals that are expected from the respective RFID cards. Typically the RFID signals will represent account numbers, or identification numbers, associated with the RFID cards.

Downstream of the high capacity feeder 23 an accumulator gathers together sheets that belong to the same collations. Downstream of the accumulator 23, and after further folding, a buffer 25 holds collations of control documents in preparation for entry into the synchronous chassis 3 portion of the inserter system. Also downstream of buffer 25, the interface module 26 feeds RFID cards on their carrier sheets onto the chassis 3.

Chassis 3 transports the mail piece collations underneath a series of insert feeders that feed various inserts, such as special offers or advertisements, onto the collations. The MRDF will typically control which inserts are provided to which collations based on a profile of the respective mail piece recipients.

The chassis 3 transports collations, including the RFID cards, to an insert station 6. Insert station 6 receives envelopes from an envelope feeder 5. Just upstream of the insert station 6, an RFID sensor module 4 is located to detect the RFID signals of cards that are about to be inserted into the envelopes. The detected RFID signals are compared to the expected signals for the respective mail pieces, as stored in the MRDF. If the detected RFID signal fails to match the expected signal for the mail piece, then an error signal is generated, and that mail piece can be flagged for outsorting. The error signal may also trigger the more drastic remedy of shutting down the inserter system so that the problem can be investigated.

In this preferred embodiment where the RFID sensor module 4 is just upstream of the insert station 6, it is preferred that the components of the insert station 6 be made of plastic, or some other non-metallic material, so that the metal will not interfere with the detection of the RFID signal.

In the preferred embodiment, the chassis 3, envelope feeder 5 and insert station 6 can be a Flowmaster inserter, as available from Pitney Bowes of Stamford, Conn., and described in U.S. Pat. No. 6,164,046, incorporated by reference herein. Downstream of the insert station 6, a flipper module 7 turns the envelope over so that various markings can be printed on the front of the envelope. At postage meter station 8 can place the appropriate postage on the envelope. At outsort station 9, mail pieces can be diverted into a special bin reserved for mail pieces for which a problem was detected. In series with the postage meter station 8, an address printing station (not shown) may be included to print addresses on envelopes that do not use a clear window. An output stacker 10 receives finished mail pieces to be taken away for transport to the delivery service.

FIG. 2 depicts further details of a card feeding and affixing module 1 that can be used with the present invention. Standard components for the card feeding and affixing module are available from Ga-Vehren Corp. of St. Louis, Mo. The card affixing module 1 consists of sub-modules which perform discrete functions to complete the feeding, scanning, affixing and folding process. Each sub-module is powered and timed via a central driveshaft that maintains correct phasing control and velocity of all elements in the system. The module is controlled by controller 26 to control timing and phase all electrically actuated components.

The “carrier” document is singulated and bottom fed out from the high capacity sheet feeder 11. The feeder cycle is conscribed by a “hard” coupling to the affixing systems main transport drive and timing shaft. The feeder 11 exit transport shaft assembly contains provision for sets of document scoring knives to score the carrier document for the plow folding process. A scanning camera 12 is in place to scan an identification code on the carrier documents as they are being fed, in order to know that the proper carrier sheet is being fed for the particular mail piece being created.

The feeder 11 feeds the carrier document into an aligning station 13 positioned on the vacuum belt transport 28. The aligner 13 can be adjusted on the fly for document height and document position on the vacuum transport belt 28.

The vacuum transport 28 runs the length of the card input module 1. The transport 28 controls the carrier document position, alignment and velocity for all subsequent operations. The transport belt 28 runs at a constant velocity during system operation. All mechanical devices are hard coupled to the transport 28 drive and track its velocity.

Cards can be affixed to the carrier document using “fugitive” adhesive which is applied by a hot melt applicator 14. The hot melt glue applicator 14 consists of a melt tank/controller unit, hose system and nozzle assembly, such as those available from Nordson Corp. of Ohio.

As an alternative to hot glue, the system can have an optional tape unit (not shown), such as the type manufactured by Straub Design Company of Minneapolis, Minn. Cards are affixed to the carrier document with double sided tape having a three to one tack ratio. Sensors on the tape system detect low tape, tape malfunction, and tape not applied. Tape length and tape spacing between cards is adjusted via settings in the controller 27.

Card feeder 15 can feed one or two plastic cards can be fed onto one document. When applying two cards to one carrier, there is a repeat spacing of 4.0″. Cards can be fed in either orientation. In one embodiment, an RFID sensor 16 can be placed proximal to the output of the card feeder 15 to detect the RFID signal of the cards being fed. Thus the controller 27 can verify that the correct card is being fed at a given time, and that the card matches the corresponding carrier document.

The “carrier” document is transported on the vacuum belt 28 past a print station 17 where an image is printed specific to the application. An encoder fixed to the vacuum transport 28 clocks the transport velocity and provides data to the print system 17 to control the imaging process.

The carrier document with card affixed is transported to and through the plow folding section 18, 19 where the pre-scored carrier document is finish folded per application specification. The carrier document can be half, “C” or “Z” folded to meet the requirements of the application.

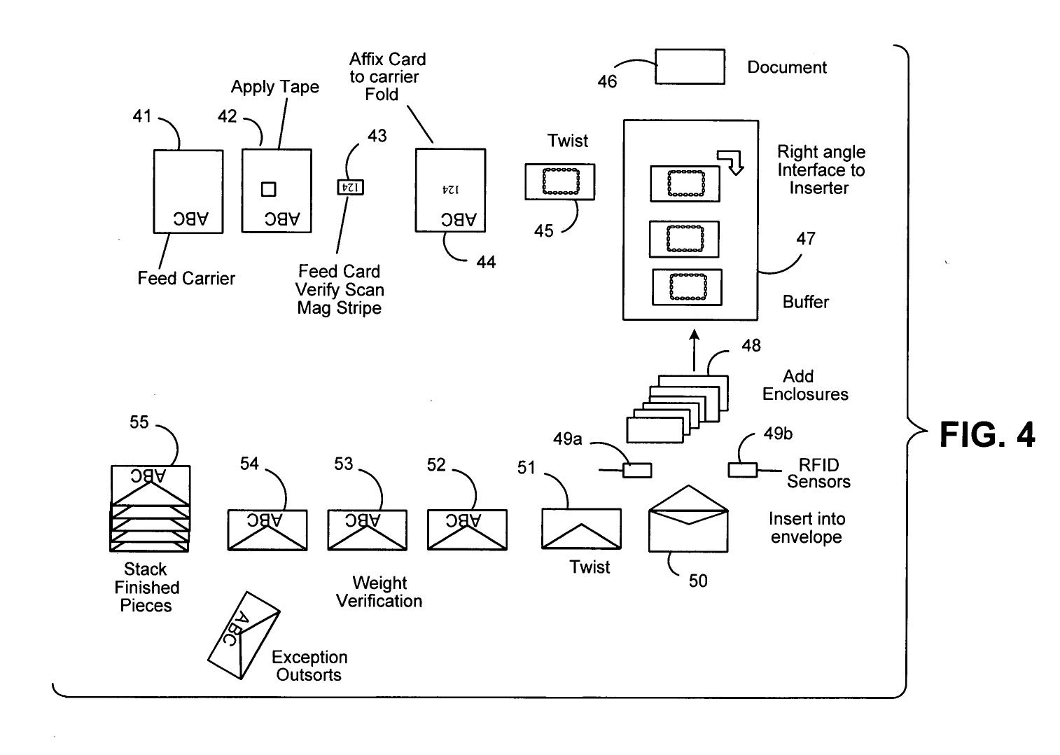

FIG. 3 depicts an exemplary arrangement of RFID cards 32a and 32b on a carrier sheet 31. RFID cards 32a and 32b include embedded RFID antenna that allow their signals to be detected by sensors. FIG. 4. depicts a series of steps 41-55 corresponding to the operation of the equipment described above in connection with FIGS. 2 and 3.

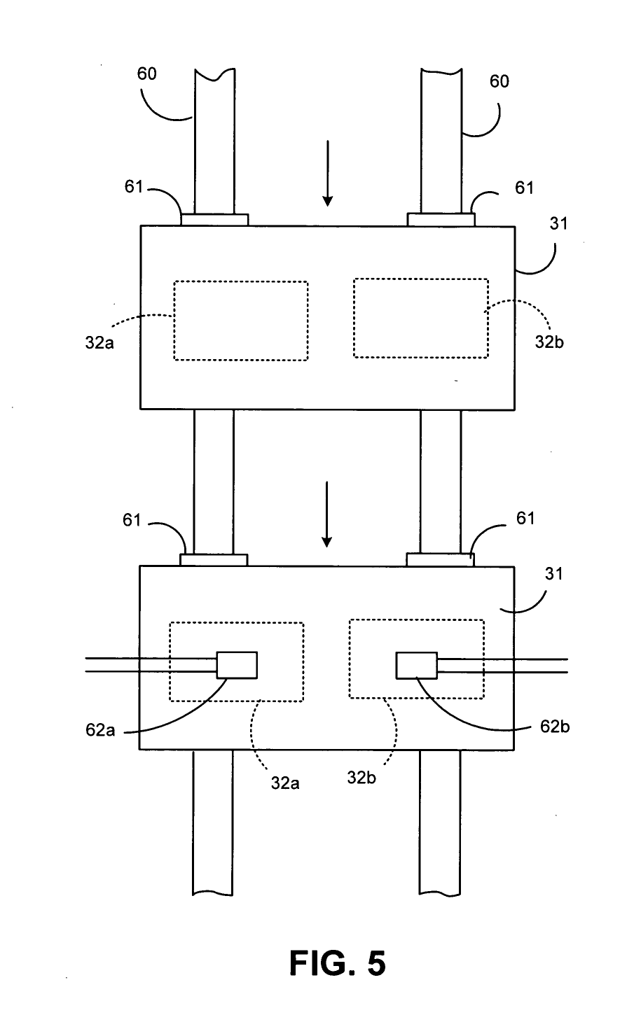

FIG. 5 depicts a preferred embodiment of the invention for detecting the presence of two RFID cards 32a and 32b inside a folded carrier 31 being transported on a chassis 3. Chassis 3 includes continuous belts 60 to which pusher fingers 61 are attached. Pusher fingers 61 push the accumulations with the carrier sheets 31 in the direction shown by the arrows. RFID sensors 62a and 62b are positioned over the document path so that they can read the RFID signals of the cards 32a and 32b as they travel by in parallel. The sensed signals from the sensors 62a and 62b are provided to the controller 27 for comparison to the expected readings for the mail piece.

Based on the RFID signals sensed, the controller 27 can tell whether the appropriate two RFID cards 32a and 32b are present. Also, the system will be able to tell whether too few, or too many cards are present. If the sensor signals do not match the expected values in the MRDF, then an error signal is generated. Based on the error signal, the problematic mail piece can be outsorted, or the inserter machine can be shut down.

In another embodiment, an RFID sensor 4 is used to verify the effectiveness of privacy protection envelopes that can be used for sending RFID cards to customers. As discussed above, an RFID card might include sensitive account or identification information in the transmitted RF signal. Since the RF signal could be scanned without opening the envelope, the customer might have no way of knowing whether a party had improperly intercepted and scanned the RF signal.

To protect against such improper interception, it is known to provide special security envelopes, fed by envelope feeder 5, that include a metal mesh that disrupts the RF signal of the cards. Thus, the improvement of this further embodiment provides an RFID sensor 4, located downstream of insert station 6, to test the stuffed envelopes to ensure that the security envelope is doing its job. The controller 27 coupled to the sensor 4 is programmed to generate an error signal if a recognizable RF signal is detected in from a stuffed envelope that passes by the sensor 4. Those envelopes can be outsorted at outsort station 9 to determine the cause of the problem. If no recognizable RF signal is detected, then the stuffed envelopes are allowed to progress to the output stacker 10.

Although the invention has been described with respect to preferred embodiments thereof, it will be understood by those skilled in the art that the foregoing and various other changes, omissions and deviations in the form and detail thereof may be made without departing from the spirit and scope of this invention.

What is claimed is:

1. A method for preparing mail pieces wherein the mail pieces include RFID enabled cards with RFID components and individual cards transmit individual RFID signals, the method comprising:
relating the individual RFID signals of the RFID enabled cards to particular mail pieces in a mail piece production database;
feeding the cards from a card feeder;
attaching the fed cards to carrier sheets;
transporting the carrier sheets with the cards during assembly of mail pieces;
inserting the carrier sheets and cards into envelopes to form mail pieces for mailing;
during transport and assembly of the carrier sheets, sensing the individual RFID signals of the cards;
comparing the sensed individual RFID signals with mail piece data in the mail piece production database; and
responsive to the sensed RFID signal, controlling processing of mail pieces based on the mail piece data corresponding to the sensed RFID signals.

2. The method of claim 1 wherein the step of controlling processing of mail pieces further includes generating an error signal if an individual RFID signal does not match the RFID signal that is expected for a particular mail piece that is expected at a location of the sensing.

3. The method of claim 2 further including a step of outsorting mail pieces for which an error signal is generated.

4. The method of claim 1 wherein the step of sensing occurs immediately upstream of the step of inserting.

5. The method of claim 1 wherein the step of attaching the cards to the carrier sheets includes attaching at least two cards on the sheet in a side-by-side arrangement.

6. The method of claim 5 wherein the step of sensing the individual RFID signals on the cards is carried out by a pair of sensors positioned to be proximal to the side-by-side cards on the carrier sheets.

7. The method of claim 1 wherein the cards are credit cards, and the RFID signals represent account numbers.

8. The method of claim 1 wherein the step of sensing occurs at a plurality of locations during mail preparation.

9. The method of claim 8 wherein the plurality of locations includes immediately downstream of the step of feeding the cards from the card feeder.

10. The method of claim 1 wherein the envelopes are RFID security envelope, the step of sensing is after the step of inserting, the step of controlling processing of mail pieces based on the mail piece data corresponding to the sensed RFID signals further includes generating an error signal if a valid RFID signal is detected.

11. An inserter system for preparing mail pieces wherein the mail pieces include RFID enabled cards with RFID components and wherein individual cards transmit individual RFID signals, the system comprising:
a control system having a mail piece database, the mail piece database including characteristics of individual mail pieces, the mail piece database further relating the individual RFID signals of the RFID enabled cards to particular mail pieces;
a card feeder arranged to feed individual cards from a stack of cards;
an attaching device downstream of the card feeder arranged to attach the fed cards to carrier sheets;
a sheet transport arranged to transport the carrier sheets with the cards during assembly of mail pieces;
an inserting mechanism arranged to insert the carrier sheets and cards into envelopes to form mail pieces for mailing;
one or more RFID sensors positioned proximal to the sheet transport to sense individual RFID signals of the cards during transport and assembly of the carrier sheets; and
wherein the control system is coupled to the sensor and is programmed to compare the sensed individual RFID signals with mail piece data in the mail piece production database and to control mail piece processing based on the mail piece data corresponding to the sensed RFID signals.

12. The system of claim 11 wherein the control system is further programmed to generate an error signal if an individual RFID signal does not match the RFID number that is expected for a particular mail piece that is expected at a location of the sensing.

13. The system of claim 12 wherein the control system controls a divert mechanism to outsort mail pieces for which an error signal is generated.

14. The system of claim 11 wherein the one or more RFID sensors are positioned immediately upstream of the inserting mechanism.

15. The system of claim 14 wherein the inserting mechanism is comprised on non-metallic parts, so as not to interfere with the RFID sensors.

16. The system of claim 11 wherein the attaching device is arranged to attach at least two cards to the carrier sheets in a side-by-side arrangement.

17. The system of claim 16 wherein the step of sensing the individual RFID signals on the cards is carried out by a pair of sensors positioned to be proximal to the side-by-side cards on the carrier sheets.

18. The system of claim 11 wherein the cards are credit cards, and the RFID signals represent account numbers.

19. The system of claim 11 wherein there are a plurality of RFID sensors located at a plurality of locations in the inserter system.

20. The system of claim 19 wherein the plurality of RFID sensors includes a sensor immediately downstream of the card feeder.

21. The system of claim 11 wherein the envelopes are RFID security envelope, the RFID sensors are positioned downstream of the inserting mechanism, and the control system is programmed to generate an error signal if a valid RFID signal is detected.
